(19) United States
(12) Patent Application Publication
(10) Pub. No.: US 2024/0062223 A1
(43) Pub. Date: Feb. 22, 2024

(54) SYSTEM AND METHOD FOR PROVIDING ENVIRONMENTAL RATING

(71) Applicant: Envira, LLC, West Windsor, NJ (US)

(72) Inventors: Praveen VARMA, West Windsor, NJ (US); Henry SHILLING, New York, NY (US); Mark GOLD, Teaneck, NJ (US)

(73) Assignee: Envira, LLC, West Windsor, NJ (US)

(21) Appl. No.: 18/270,548

(22) PCT Filed: Dec. 30, 2020
(86) PCT No.: PCT/US2020/067475

§ 371 Date: Jun. 30, 2023

(51) Int. Cl. G06Q 30/018

(52) U.S. Cl. CPC G06Q 30/018

(57) ABSTRACT

According to various embodiments, a system for providing an environmental rating to an entity is disclosed. The system includes one or more processors configured to determine a point in time (PIT) rating. The PIT rating is determined by: receiving an entity-specific unremediated emissions amount for a predetermined period of time; receiving an entity-specific scaling measure for the predetermined period of time; receiving external cost values for each entity-specific unremediated emission; determining an aggregate external cost for the entity based on the entity-specific unremediated emission amount and each associated external cost value; determining an indicative rating ratio based on the aggregate external cost for the entity and the entity-specific scaling measure; comparing the indicative rating ratio to categories in a ratio rating table and select a rating defined by an interval into which the indicative rating ratio falls; and outputting the selected rating.

### FIELD OF THE INVENTION

The present invention relates generally to environmental ratings and, more particularly, to a system and method for providing environmental ratings for an entity based on unremediated economic and social costs of pollution associated with entity activities which are not captured in the system of input and product prices, normalized by an appropriate measure of entity scale.

### BACKGROUND OF THE INVENTION

While markets facilitate the efficient allocation of resources, they do so imperfectly. One such problem is that of externalities, i.e., costs of productive activity which are not included and recovered in the system of input and output market prices. Examples of externalities are unrecovered costs of pollution and environmental degradation. A particularly important case is that of greenhouse gas (GHG) emissions.

These unrecovered costs can be considerable. The impact of chemical and particulate air pollution on health has been estimated at $5.11 trillion in welfare losses globally for 2013. Climate change is also having significant adverse effects. The Interagency Working Group on the Social Cost of Carbon established by the Obama administration estimated such losses to be about $47 per metric ton of GHG emissions. When multiplied by the total amount of GHG produced, for example, 37.1 billion metric tons in 2018, the social cost of CO₂ produced in just one year translates to roughly $1.5 trillion for 2018 alone, more than $200 per person on earth. Pollutants in soil and water impose considerable costs as well. These include hazardous combustion residuals and chemicals used in mining and fracking as well as agricultural (livestock as well as crops) waste and fertilizer runoff.

To address the problems and social costs involved in polluting activities, governments use i) regulation, ii) remediation, and iii) taxation. Regulation establishes research, standards, rules, prohibitions, and enforcement actions. It has been successful in limiting certain kinds of toxic polluting activities. Remediation involves the clean-up of polluted land, water, and air. In most Western democracies, the concept that “the polluter pays” is embedded into law, but as a practical matter, the polluter often can evade payment. Regimes of taxation for certain types of polluting activities or polluting business sectors have been implemented but only in a limited way. Often, the taxes are set below widely accepted social cost estimates and on occasion, are simply allowed to lapse.

Part of the problem in reintroducing the social costs of pollution back into the pricing system through taxes or other methods is the lack of information available to the public in a readily approachable form. If information was more widely available and was more easily understandable, the public would be more aware of the burdens they were carrying, governments would have more clear reference points to organize taxation or cost recovery plans, and investors would also have benchmarks to guide their analysis and plans. The existing systems do not speak to the unremediated social cost of pollution caused by an entity.

To facilitate clarity regarding corporate social responsibility and socially responsible investing, the United Nations launched a series of initiatives beginning with the Global Reporting Initiative (1997) promoting transparency regarding environmental impact, working conditions, and financial reporting. This was followed by the Global Compact (2000, 2003) which was a set of principals guiding corporate behavior with respect to human rights, labor practices, the environment, resistance to corruption. The UNEP FI report (2004) on “the materiality of environmental, social, and corporate governance considerations and criteria as they relate to the portfolio management of mutual and other institutional funds,” concluded that “environmental, social, and corporate governance criteria affect shareholder value both in the short and long term.” The Principles for Responsible Investment (2006) established a voluntary and aspirational set of investment principles for institutional investors that include the integration of environmental, social, and governance (ESG) issues into analysis and investment decision making. Today, signatories include about 2,500 organizations that are responsible for around $90 trillion in worldwide assets under management.

In connection with growing investor interest in promoting positive societal outcomes, investment funds have been established with investment guidelines designed to pursue sustainable investing strategies. These funds have gained traction in the last five years and since the signing of the Paris Climate Agreement at the end of 2015.

In a similar vein to explicitly ESG associated funds, a new debt instrument has emerged designed to meet demands for socially responsible investing. Launched by the European Investment Bank (EIB) in 2007 and followed in short order with an offering by the World Bank (International Bank for Reconstruction and Development, IBRD) in partnership with Skandivaviska Enskilda Banken (SEB) to meet the demands of institutional investors by extending the EIB framework to focus on transparency and reporting, “Green bonds” are defined as fixed-income securities, both taxable and tax-exempt, that raise capital exclusively for use in projects or activities with specific climate or environmental sustainability purposes. These include senior unsecured obligations with direct recourse to issuers, project finance or revenue bonds, with and without recourse to issuers, and securitizations that collateralize projects or assets whose cash flows provide the first source of repayment. Regardless of structure, green bonds are generally issued pursuant to a set of voluntary guidelines or frameworks. A key voluntary guidelines framework in the form of green bond best practices was formulated in 2014 by a consortium of U.S., European banks, led by Citi, JPMorgan, Bank of America/ML in the US and Credit Agricole in Europe, that came to be known as the Green Bond Principles (GBP), now administered by the International Capital Markets Association (ICMA). With their emphasis on transparency, disclosure, and standards setting, these organizations, working together, catalyzed the green bonds market by codifying a set of voluntary guidelines for green bonds that include criteria for the use of proceeds, the issuer's process for project evaluation, the management of proceeds, and reporting on a periodic basis. In the process, the GBP served to expand the eligible security types and issuer base to include financial institutions, corporations, sovereigns, sub-sovereigns. Green Bonds assessments do not measure the environmental externalities of the issuer, they only certify the use of the particular bond's proceeds.

Nationally Recognized Statistical Rating Organizations (NRSROs), which are in the business of rating the credit quality of issuers and other obligors, have moved to promote transparency regarding the way in which ESG issues impact rating decisions. While these disclosures are helpful, the ESG issues themselves are not the subjects of these ratings, but rather the credit quality of the respective rated entities are the subjects. NRSROs have also become involved in rating Green bonds. These ratings, like the bonds being rated, speak to the use of the proceeds, but not the environmental impacts or costs of pollution generated or reduced, in general, by the issuer or the proceeds from the instrument.

Credit rating agencies have attempted to provide ESG grades; these “grades” qualitatively address Environment (E), Social(S) and Governance (G), together ESG aspects of a company or its funding activities. For example, Moody's provides ESG grades for Green Bonds based on the stated use of proceeds. Such stated use of proceeds includes amelioration of existing pollution issues or investing in new “green initiatives.” Fitch's ESG relevance scores do not evaluate the ESG characteristics of the issuer per se; rather, they measure the extent to which ESG considerations impact (and are relevant) to the determination of a credit rating for the issuer. None of these scores or ratings speak to the pollution caused by these companies and the social costs transferred to society. In fact, a company might end up receiving a higher credit rating if the company is able to transfer all such pollution costs to the society because all profitability and other credit measures used by rating agencies are likely to be better for such a company than for a company that pays for pollution control measures. To their credit, rating agencies have stated that they account for all “risks to the company”, which would include relevant regulatory risks, when assigning a credit rating. However, corporate credit ratings are, in a large part, a function of balance sheet and income statement measures. Two companies operating in the same industry with exactly same operating characteristics are likely to get two very different ratings if they have very different leverage ratios. While they may face the same “regulatory risk”, it is neither quantified nor discussed in a credit rating opinion.

Current methods, including those by every ratings agency, Moody's, S&P, and Fitch, do not address the issue of social/economic cost of pollution. As such, there is a need for an environmental rating system that considers environmental externalities.

### SUMMARY OF THE INVENTION

According to various embodiments, a system for providing an environmental rating to an entity is disclosed. The system includes one or more processors configured to determine a point in time (PIT) rating. The PIT rating is determined by: receiving an entity-specific unremediated emissions amount for a predetermined period of time; receiving an entity-specific scaling measure for the predetermined period of time; receiving external cost values for each entity-specific unremediated emission; determining an aggregate external cost for the entity based on the entity-specific unremediated emission amount and each associated external cost value; determining an indicative rating ratio based on the aggregate external cost for the entity and the entity-specific scaling measure; comparing the indicative rating ratio to categories in a ratio rating table and select a rating defined by an interval into which the indicative rating ratio falls; and outputting the selected rating.

According to various embodiments, a method for providing an environmental rating to an entity is disclosed. The method includes determining a point in time (PIT) rating via a PIT ratings module of one or more processors by: receiving an entity-specific unremediated emissions amount for a predetermined period of time; receiving an entity-specific scaling measure for the predetermined period of time; receiving external cost values for each entity-specific unremediated emission; determining an aggregate external cost for the entity based on the entity-specific unremediated emission amount and each associated external cost value; determining an indicative rating ratio based on the aggregate external cost for the entity and the entity-specific scaling measure; comparing the indicative rating ratio to categories in a ratio rating table and selecting a rating defined by an interval into which the indicative rating ratio falls; and outputting the selected rating.

According to various embodiments, a non-transitory computer-readable medium having stored thereon a computer program for execution by a processor configured to perform a method for providing an environmental rating to an entity is disclosed. The method includes determining a point in time (PIT) rating by: receiving an entity-specific unremediated emissions amount for a predetermined period of time; receiving an entity-specific scaling measure for the predetermined period of time; receiving external cost values for each entity-specific unremediated emission; determining an aggregate external cost for the entity based on the entity-specific unremediated emission amount and each associated external cost value; determining an indicative rating ratio based on the aggregate external cost for the entity and the entity-specific scaling measure; comparing the indicative rating ratio to categories in a ratio rating table and selecting a rating defined by an interval into which the indicative rating ratio falls; and outputting the selected rating.

According to various embodiments, the processors of the system, method, and non-transitory computer-readable medium are further configured to determine a forward looking rating by modeling a future path of the outputted PIT rating via a stochastic process with a trend and a periodic probabilistic shock and adjusting the outputted PIT rating based on the modeled future path.

According to various embodiments, the processors of the system, method, and non-transitory computer-readable medium are further configured to monitor factors that impact the environmental rating of the entity to determine when the PIT rating should be updated.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1 depicts a ratings table according to an embodiment of the present invention;

FIG. 2 depicts a list of entity types rated and relevant measures of economic output which may be included in scaling measures where data permit according to an embodiment of the present invention;

FIG. 3 depicts a block diagram of a system for implementing the environmental ratings according to an embodiment of the present invention;

FIG. 4 depicts a flow chart for determining a point in time rating according to an embodiment of the present invention;

FIG. 5 depicts a flow chart for determining a forward output rating according to an embodiment of the present invention;

FIG. 6 depicts a table of initial and terminal outcomes for respective emissions according to an embodiment of the present invention; and

FIG. 7 depicts a flow chart for a rating surveillance and monitoring system according to an embodiment of the present invention.

### DETAILED DESCRIPTION OF THE INVENTION

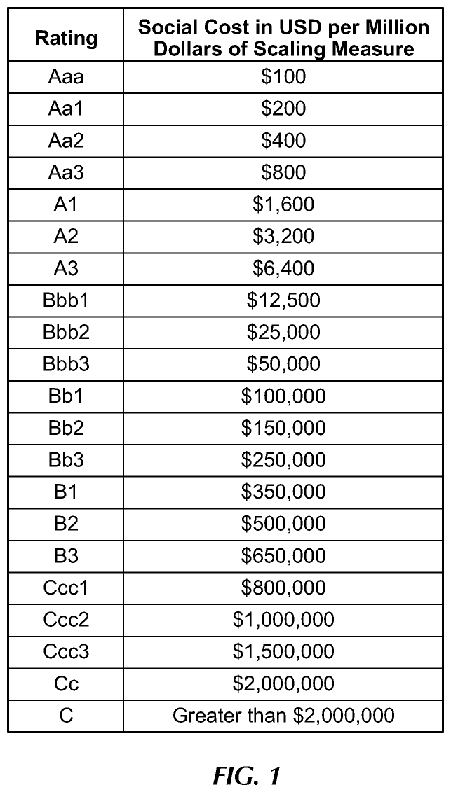

Generally disclosed herein are embodiments for an environmental rating system and method. The environment rating system and method rates entities based on the appropriately scaled cost of unremedied pollution associated with its operation. An entity can be defined as a person or a group of persons organized to engage in an economic activity regardless of for-profit (e.g. a business organization) or not-for-profit (e.g. an academic institution), a municipal, county, state, or central (federal) government, a municipality, county, state, or a country, or a multilateral body (e.g. The United Nations, International Monetary Fund). The objective of this rating system is to more fully account for environmental externalities which are created when entities pass a portion of pollution costs on society to bear. The rating system includes socio-economic costs of known emissions that pollute the environment (air, water, soil) emitted by the rated entity per unit of activity. An illustrative table is shown in FIG. 1 (in which the unit of activity is $1 million dollars of (adjusted) revenue, as a nonlimiting example of a scaling measure of activity).

Embodiments of the rating system can be used in many nonlimiting ways. It can be used by policymakers and regulators to impose regulations that require entities to internalize costs of externalities based on the rating generated from this rating system. It can be used by credit rating agencies as a direct input to their credit analysis and for providing credit ratings. Since the proposed rating system quantifies the cost of externalities in monetary terms, credit rating agencies can use the environmental ratings to calibrate financial data to appropriately reflect the environmental costs companies might be forced by regulation to internalize. It can be used by asset managers and investors interested in investing in companies that are creating less environmental damage to society. The proposed ratings delineate the best from the worst companies along the pollution dimension, offering investors clear and easy to understand choices. It can be used by entities themselves, in performing self-assessment and identifying ways to improve their ratings and executing strategies to do so. It can be used by environmentally conscious consumers, who may choose to buy products from companies (or entities) that are rated higher on the proposed rating scale.

A desirable environmental rating system would be one that: i) is widely recognized and understood; ii) is comparable across industries, regions, and size; iii) incorporates available relevant information related to amounts and social costs of known pollution associated with the activities of the rated entity; iv) is independent of financial condition measures—for example, debt or leverage ratios typically used by investors and credit rating agencies to come to investment decisions; iv) helps investors make informed investment decisions; v) comparable across entities; and vi) assists policymakers and governments in making policy decisions regarding taxation, licensing, industry makeup among other policy aspects. For certain purposes it may be helpful if the measure is prospective in nature.

The mechanics of embodiments of the rating system are grounded in its defined metrics and based on a proprietary system of estimating environmental externalities resulting from an entity's (commercial or otherwise) activities. The term environment here includes air, water, space, and soil. The economic cost of pollution is then normalized, as appropriate, to account for activity scale. Since an entity can cause any of a wide array of environment effects, for example, air pollution (e.g., Carbon Oxides, Nitrogen Oxides, Sulfur Oxides, particulate matters like PM2.5, PM10, etc.), water pollution (e.g. PCP in rivers, effluents in ground water), or land pollution (e.g. carcinogenic toxins in soil) a comprehensive list of the current known pollutants is created and their economic costs are estimated for purposes of calculating a rating. The list of pollutants and associated social costs per unit of unremediated emission may be updated later upon the receipt of new information.

It is envisioned that these ratings, once assigned, would be subject to an automated surveillance and would change on the basis of relevant changes in entity behavior as well as changes in the social impact of that behavior. Additionally, when the social costs of pollutants are modified, the ratings can change. It is envisioned that all ratings would be reviewed periodically for accuracy to ascertain whether the actual environmental impact of rated activity, as a whole, conformed on a reasonable probabilistic basis with projections.

The basic measurement upon which the environmental rating system proposed here is founded, is of a ratio: environmental externality per unit of activity for an entity. The term entity and activity are used here as general terms; however, the system is capable of measuring externalities for any entity. Activity is measured in terms of units appropriate for the entity type.

Some particular ratings include but are not limited to the following.

A Direct Entity Output Point in Time (PIT) Rating is measured in terms of appropriately scaled annual externalities associated directly with the entity's output activities per unit entity's annual output appropriately adjusted for purchases for resale or other relevant entity specific matters where such matters constitute a material component of entity activity and where information on such matters is either readily available, or can be estimated or simulated.

A Direct and Indirect Entity Output Point in Time (PIT) Rating is measured in terms of appropriately scaled annual externalities associated directly and indirectly with the entity's output activities per unit entity's annual output appropriately adjusted for any entity specific matters where such matters constitute a material component of entity activity and where information on such matters is either readily available, or can be estimated or simulated and where there is an acceptable amount of data to support a reasonable estimation or perform a simulation.

A Direct Entity Output Forward Rating is measured in terms of appropriately scaled projected annual externalities associated directly with the entity's output activities per unit entity's projected annual output appropriately adjusted for purchases for resale and for any entity specific matters where such matters constitute a material component of entity activity and where information on such matters is either readily available, or can be estimated or simulated and where there is an acceptable amount of data to support a reasonable estimation or perform a simulation.

A Direct and Indirect Entity Output Forward Rating is measured in terms of appropriately scaled projected annual externalities associated directly and indirectly with the entity's annual output appropriately adjusted for any entity specific matters where such matters constitute a material component of entity activity and where information on such matters is either readily available, or can be estimated or simulated and where there is an acceptable amount of data to support a reasonable estimation or perform a simulation.

In the ratings described above, the term “direct” refers to externalities associated directly with the operations of the entity being rated. “Indirect” refers to externalities associated with the production of inputs used or consumed in the operations of the entity being rated.

Definition of Environmental Ratings

It is important to define the disclosed environmental ratings implemented in embodiments described herein.

The environmental ratings disclosed here are a single measure of the various types of environmental externalities produced by a company per an appropriate scale normalization. They do not depend upon financial ratios or other credit artifacts and are designed to achieve only two objectives:

(1) Unambiguously rate entities based on the social costs, appropriately normalized for scale, which they are transferring to the society; and

(2) Act as a standalone indicator that can be used to price such transference and help market participants, including investors and regulators, take such information into their investment and regulatory decision making.

Absolute vs Relative Ratings System

The first step for the disclosed environmental rating system is a consideration of the type of rating system that will achieve the above objectives. The following two options are considered: Relative Rating System and Absolute Rating System.

These terms in credit ratings have well-defined meanings and interpretations. A relative ranking system is one in which entities are rank-ordered relative to each other but not to any specified external measure. In the case of relative credit ratings, one can say that a more highly rated entity is of stronger credit quality and less likely to default or impose credit losses on its obligations relative to a lower rated entity. Absolute ratings, on the other hand, are anchored to specified measures; for example, an absolute credit rating would be connected to some specific probability of default (PD) which is then “bucketed” into a rating scale. Both of these credit rating systems speak to creditworthiness of an obligor in ways which are comparable across industries, regions, and size. For example, a Baal rating (as assigned by Moody's) has the same meaning for obligors in steel, mining, banking, or any other industry; a buyer of the debt need not worry about idiosyncratic factors of a particular industry when analyzing agency rated debt.

However, in the case of environmental ratings, absolute ratings and relative ratings can take on a different meaning (or interpretation) from those in the case of credit ratings. For example, consider two industries that create vastly different amounts and types of pollutants: power generation and meatpacking. Because these industries by their nature create different types and amounts of pollutants, a reasonable question arises: Should companies operating in these industries be rated using different standards that take into account the inherent nature of the industry or should companies in both industries be evaluated independently of their industries' respective inherent characteristics.

It is an important question that needs to be resolved at the outset because these two ratings systems lead to two different interpretations of environmental ratings. In a relative ranking system, it is likely that environmental ratings will become industry specific. Continuing with the example of power generation and meatpacking industries, for the sake of illustration, assume that power generation industry produces less pollution per standardized unit of output than the meatpacking industry. In such a scenario, the power generation industry will get a higher rating and power generation companies will get ratings that will be notched up or down relative to this industry rating based on the amount of pollution they produce relative to the industry average. This relative notching will need to be constrained both up and down to maintain the relevance of the industry rating. However, this constraint has the potential of penalizing companies within that industry that are outliers in their pollution performance. For example, a power producer that produces 100% of its power using renewables (solar, hydroelectric, and wind etc.) would be constrained to a rating that is likely to be much lower than what it truly deserves. Perversely, poor performers in the industry will end up getting the benefit of constrained notching and will end up receiving ratings higher than what they truly deserve. Obviously, one easy solution is to not constrain the notching, effectively breaking the nexus between industry ratings and companies' ratings. But that simply leads to absolute ratings.

Secondly, relative ratings with constrained notching within an industry lead to incomparability across industries. To use environmental ratings for investing purposes, market participants should be able to use the environmental rating as an input that includes all environmental factors about a company regardless of the industry in which the company operates. So, in our example, a company in power generation industry that is rated Bbb3 on environment factors should have the same environmental attributes as a company rated Bbb3 in the meatpacking industry. This is only possible with absolute environmental ratings. As such, the rating system disclosed herein is an absolute rating system.

Ratings Scale

Embodiments of the disclosed rating system can include a rating scale similar to a credit rating scale, running from Aaa (the highest grade−lowest scaled pollution) to C(lowest grade−highest scaled pollution), though this is only exemplary and not intended to be limiting. While there are other scales that even credit rating agencies are using, the scale disclosed herein is one in which markets are familiar and provide enough separation (and granularity) between grades.

FIG. 1 depicts a ratings table according to an embodiment of the present invention. The numbers associated with the ratings Aaa through C represent the lower bound for the associated rating category. Most simply, the rating scale rank-orders rated entities based on a standardized measure of unremediated pollution per unit time over a standard unit of activity over the same time interval, as further described in detail herein. For this rating scale to be universally applicable, “standardized unit of entity activity” and “standardized unit of unremediated pollution” should be defined.

Standardized Unit of Entity Activity:

To be able to compare pollution across various industries, a standardized unit of activity is needed for scaling purposes. Various industries use different measures of economic output for year-over-year (Y—O—Y) comparisons. They do so to strip out the effect of inflation or other monetary aspects of their business. For example, passenger airlines report on million-passenger-miles, and the steel industry reports on millions of tons. The power industry reports in terms of BTUs (British Thermal Units) or MWh (Megawatt per hour), while car companies use millions of cars.

These economic activity measures, while useful for particular industries, cannot be used for the disclosed rating scale for the obvious reason: X tons of GHG per MWh does not compare to Y tons of GHG per million-passenger-miles, for example. Therefore, a unit of activity needs to be defined that is: (a) observable through publicly available data, (b) not easy to manipulate, (c) is comparable across industries, and (d) can reasonably represent a measure of activity. For the embodiments disclosed herein, an appropriate monetary measure is taken to be the standard unit of activity; in this way it is possible to compare entities both within and across sectors. Entities can be compared in terms of a common metric while removing sector-specific j argon.

Ratings contemplated in embodiments of this invention include:

(1) A Direct Entity Output Point in Time Rating;

(2) A Direct and Indirect Entity Output Point in Time Rating;

(3) A Direct Entity Output Forward Rating; and

(4) A Direct and Indirect Entity Output Forward Rating.

These are discussed in more detail below.

Appropriate scaling measures are specific to the particular type of rating contemplated as well as the entity being rated. In various cases, more than one type of scaling measure may be appropriate. Specific scaling measure candidates for respective cases are listed herein. The choice of scaling measure, when more than one appropriate measure is conceivable, is based upon factors such as the quality and general availability of information.

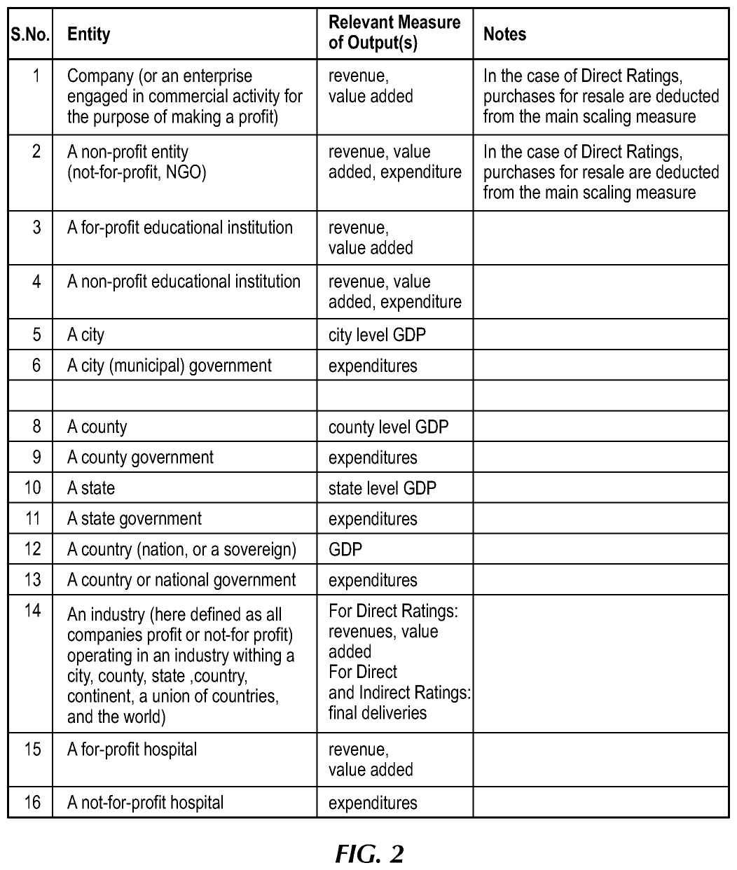

FIG. 2 shows a non-limiting list of the type of entities rated and the relevant measure(s) of economic output which may be selected for use as part of a scaling measure where data permit.

Measuring Pollution Across Industries:

One could argue that once the standardized output of activity has been defined there is no need for a rating metric, as the absolute amount of pollution appropriately normalized for scale is the purest indicator of the social cost transference and should therefore be used for decision making purposes. While theoretically that may be true, a rating system allows for compressing such absolute numbers into more manageable categories that can be used for more meaningful decision making. For example, how would one compare company A which produces 411 tons of CO₂ and 2 tons of PM_{2.5} per million dollars of revenue versus company B that produces 500 tons of N₂O per million dollars of revenue. To compare and rate these companies, the unit of pollution needs to be standardized too. The second challenge, therefore, is to find a common metric through which the amount of all types of pollution produced by industries can be measured. For example, the meatpacking industry produces methane (livestock effluents), while steel industry produces not only GHG but also PM2.5 and PM10. Similarly, the electrical power industry not only produces different amounts and types of GHG based on different inputs (coal, gas, solar, etc.) but within an input like coal, different grades of coal (for example, anthracite, lignite, and bituminous) produce GHGs of different compositions as well as ash, NOₓ, SO₂, etc. in varying amounts. One can think of countless such examples. Such variations among different industries create analytical challenges for any rating system.

The environmental rating system described herein, however, is not simply a measure of effluents or emissions. It is a measurement system that assesses environmental externalities. These costs are measured in monetary terms. Defining the rating system in terms of environmental externalities not only establishes a more specific meaning to the measure; it establishes a measurement system that can be applied across various pollutants.

Keeping aside for the moment the different types of pollutants, even if a single pollutant like CO₂ was the only concern, a rating scale would still be needed. For example, how does one compare between absolute numbers like 411 tons of CO₂ emissions versus 418 tons CO₂ emissions per million dollars of revenue for investment or other analysis. Such absolute numbers introduce artificial finesse in the analysis and decision making that may not be meaningful. A rating scale which removes such artificial finesse while retaining its usability is still needed.

For the ratings scale to be meaningful, two boundary conditions are needed as bookends: The highest rating of Aaa is reserved for companies that produce minimal scaled externalities, while the lowest rating of C is reserved for companies that produce extreme scaled externalities. The benefits of such a scale are clear. The scale eliminates any complexity in presentation and understanding of a particular rating and translates all type of pollution from every industry to a single, easily understood and universally applicable number. For example, a Bbb1 rated company in steel industry is imposing no more than $12,500 of social cost on society per million dollars of (adjusted) revenue which is less than a B3 rated company in automobile industry which is causing more than $500,000 of social cost to society per million dollars of (adjusted) revenue (but no more than $650,000). Thus, this scale makes entity comparisons possible across industry, region, regulation, and type of pollution complexity.

System Overview

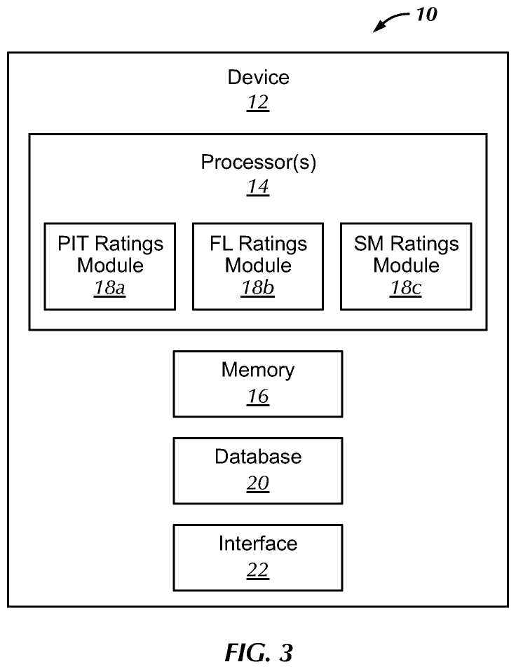

FIG. 3 illustrates a system 10 configured to implement the environmental ratings system described herein. Generally, the system 10 includes software code configured to assign a standalone Point-in-Time (PIT) environmental rating to an entity that is engaged in economic activity as well as assign a PIT rating to a group of economic entities (referred to herein as an “Industry”) based on common characteristics of products, processes, or regulation. A PIT environmental rating can also be assigned to a national government, country, state government, state, county government, county, city government, and city, as nonlimiting examples. The software code is further configured to assign standalone forward-looking environmental ratings to an entity that is engaged in economic activity. A stand-alone forward-looking environmental rating can also be assigned to a national government, country, state government, state, county government, county, city government, and city, as nonlimiting examples. The software code is additionally configured with a surveillance and monitoring system for ensuring the environmental ratings are updated over time.

The system 10 includes a device 12, which may be implemented in a variety of configurations including general computing devices such as but not limited to desktop computers, laptop computers, and network appliances or mobile devices such as but not limited to mobile phones, smart phones, smart watches, and tablet computers. The variety of configurations may include one or more central processing units (CPUs), one or more graphics processing unit (GPUs), or one or more application-specific integrated circuits (ASICs), as nonlimiting examples. The device 12 includes one or more processors 14 for performing specific functions and memory 16 for storing those functions.

The processors 14 include a PIT ratings module 18a, a forward looking (FL) module 18b, and a surveillance and monitoring (SM) module 18c for implementing the disclosed ratings approaches generally described above and to be more specifically described below. The framework for the ratings modules 18a-c will be described in greater detail below. Generally though, the ratings modules 18a-c are configured to calculate a PIT rating, a forward-looking rating for an existing entity, a forward-looking rating for an entity that has recently begun operating, a forward-looking rating for an entity that has yet to start operating, and to monitor and surveil the entity to ensure the PIT and Forward Ratings incorporate all information to support or modify existing ratings.

The device 12 further includes a database 20 for storing information. It should be noted that the database 20 may be integrated in the device 12 (as shown in FIG. 3) or be remote and readily accessible via a network (not shown) such as but not limited to wired networks, wireless telecommunications networks, WiFi, Bluetooth, Zigbee, or other communications networks. The database 20 stores information about at least one entity, unremediated emissions of the entity, unremediated emissions of products of the entity, and events related to the entity (e.g. significant asset sales, restructuring, mergers or acquisitions, significant litigation). The database 20 also stores information on relevant pollutants/emissions and the economic, social, health, and any other external costs of those relevant pollutants/emissions. The database 20 stores information on the entity, entity type, and tables that store different information based on the entity type. For example, the entity type “company” uses the table that stores information on company revenue, appropriate adjustments to company revenue, relevant corporate structure details, and relevant emissions information for the company, its industry, rules and regulations specific to that company and its industry. The database 20 further stores information regarding correlations and covariances of respective entity unremediated emissions and revenues, gross domestic product deflator values and necessary projections, and environmental rating category definitions.

The device further includes a user interface 22 for allowing a user (human or an artificial intelligence-based system) to review, modify, approve, reject and/or manually enter and update the information stored in the database 20. This information includes information about at least one entity, emissions of the entity, relevant financial information of the entity, projected emissions and financial trends of the entity, events of the entity, relevant pollutants/emissions, and the economic, social, health, and other external costs of those relevant pollutants/emissions.

Approach for Determining Point in Time (PIT) Output Ratings

The following steps are used by the ratings module 18a in determining a PIT rating for an entity. The ratings module 18a retrieves from the database 20 appropriate entity specific unremediated emissions amounts for a recent year. The ratings module 18a retrieves from the database 20 entity specific information regarding entity's annual activity in the corresponding year appropriately adjusted for any matter (e.g. in the case of Direct Entity Ratings, purchases for resale) where such a matter constitutes a material element involved in the reasoned representation of entity activity and where information on such a matter is either readily available, can be estimated or simulated, and where there is an acceptable amount of data to support a reasonable estimation or perform a simulation. The entity output is thus called Adjusted Activity. The rating module 18a analyzes the entity output and based on Artificial Intelligence (AI) logic built into the ratings module 18a decides whether a PIT rating will be a Direct PIT rating or a Direct and Indirect PIT rating. Some nonlimiting examples of AI logic include support vector machines and random forest.

The ratings module 18a retrieves from the database 20 unit-external cost values for each respective emission. Then, the ratings module 18a multiplies each entity specific unremediated emission level by its associated unit external cost (value). The products are summed across all unremediated emission classes to determine an aggregate external cost for the entity.

The ratings module 18a normalizes entity aggregate external cost by dividing aggregate external cost by entity Adjusted Activity. This establishes an indicative rating ratio. The ratings module 18a expresses the ratio in units corresponding to units in a Ratio Rating Table. The ratings module 18a compares the entity specific indicative rating ratio to categories in the Ratio Rating Table and selects the rating defined by an interval into which the entity indicative rating ratio falls. The selected rating is the indicative PIT Output Rating.

The process described for ratings module 18a is an illustrative process. The rating module 18a follows different paths of analysis and different software threads based on the type of entity selected in the user interface 22 as well as social costs associated with a rating. Social costs are likely to change as more information is available on the social costs which by themselves are a function of the variety and scale of damage caused to the living, water, soil and air, the costs to remediate such damage, the time it would take for the emissions to dissipate to a degree when they become more or less harmless, and the present value of the financial costs which is a function of time and interest rates.

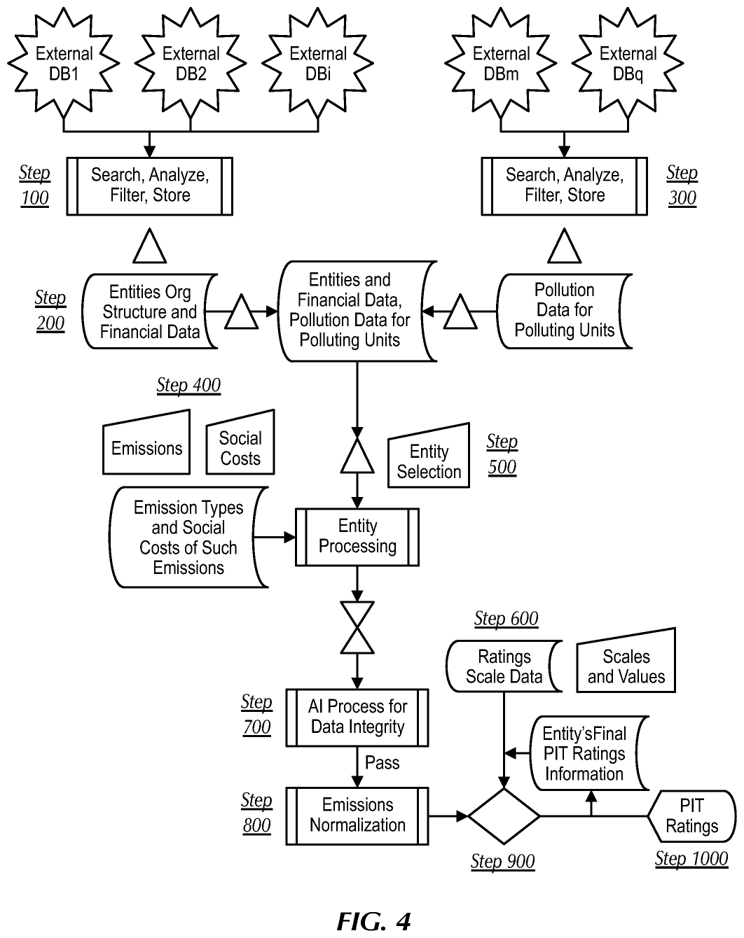

FIG. 4 generally depicts a flow chart for determining PIT ratings. Based on the type of entity entered by a user using Interface 22, at Step 100, the ratings module 18a scans various internal and external databases and sources, including public and privately available data sources, using connectors, or API, to search for the entity (or entities) and related information. The software uses a Natural Language Process (NLP) to identify entities that are of interest, as there can be many entities with similar (or even same names). The search function can be self-learning and uses fuzzy logic to identify entities of interest.

The search parameters include but are not limited to: Name of the entity and/or entity identifiers; Location; Type of the entity; Any financial instruments ID; Government ID; and Industry. Based on the search parameters provided, the software establishes a target entity list, creates its organizational structure, and captures relevant engineering, input, output, and financial information. Step 100 returns a log which is displayed at User Interface 22. Within Step 100 and the other steps are procedures allowing the user to review, modify, update, add and approve, correct, add, delete, or in case Step 100 returns a “null” response, to manually create an entity and update its organizational structure, and capture relevant engineering, input, output, and financial information.

At Step 200, the most accurate information about the entity including its financial information is extracted, processed, and stored. The system checks if the most updated information is available. The processing is done based on a Rules Engine that is updated as needed.

The Rules Engine is designed to ensure that the right financial metrics are used in our ratings process. The Rules Engine is a key software component that allows for industry and entity specific rules for analyzing the financial reports and documents of an entity. In general, the environmental rating procedure described in this claim involves the determination of externalities associated with the activities or use of an entity under rating consideration, normalized by an appropriate measure, typically a measure of activity over the same time interval as the one for which emissions were measured. The Rules Engine is a system which moves this concept from the general to the particular to refine the normalization process to make it appropriate for the entity and the rating being considered. Depending on the entity and industry chosen, the Rules Engine calls different software threads within the ratings module 18a.

As the environmental rating system is designed to be used generally for any industry or entity, including a commercial, geopolitical or state/public entity, the software needs to ensure that all appropriate metrics are analyzed, stored, and used for estimation and normalization of social costs imposed by an entity on the society. The Rules Engine establishes the appropriate normalization procedure conditioned on the specifics of the entity being rated and the type of rating being considered. For example, if the entity being rated is involved in the operations of a production process, and the rating is with regard to externalities directly associated with those processes, the normalization would be a division by revenue adjusted to remove purchases for resale. If the entity being rated is an industry and the rating was about externalities directly and indirectly associated with the operations of the industry, normalization would involve division by a nominal final delivery. For example, in case of an entity operating in electricity generation industry, financial metrics are different than say from an entity that operates in oil exploration industry. In case of an electricity producing entity, there are financial metrics related to owned plants versus operated plants as many entities own some production capacity outright and operate electricity generation units owned by others. They also purchase power from other electricity generating companies. In case of a company in oil exploration, the metrics are different, here looking at proven reserves, probable reserves (how much oil a company has discovered underground, and how certain they are about it). This information is needed to forecast emissions footprint of the oil company. In case of country ratings, the financial information is related to GDP and various industries' outputs in that country. In the case of a governmental body, normalization would involve information on expenditures. The rules engine contains the logic for each class of entities and what metrics are needed for an entity operating in a particular class.

At Step 300, the software scans various external public and private data sources using connectors, or API, to search for an entity (or entities) and related information regarding each polluting production unit, its location, and owner(s) and operator. Using AI based information scanning, the software identifies the polluting production unit and the types of inputs used and outputs produced. Based on a proprietary rules engine programmed into the software, in Step 300, the software populates appropriate data in various database tables. For example, once the polluting unit is identified as an electricity generation plant, the data is populated in tables designed specifically for electricity generation plants. Data tables in the database are designed to store data for every industry, entity and or product. This data is presented to the user, allowing the user to review, modify, update, add and approve, correction, addition, deletion, or to manually create an entity and update its organizational structure, and captures relevant engineering, input, output, and financial information.

Step 400 involves a user interface 22 that is used to review, confirm and/or update input type of emissions, list of harmful chemicals, effluents, runs-off, and other polluting byproducts of an entity. Additionally, in Step 400, the social costs are also reviewed, confirmed and/or updated in the database. Social costs of a pollutant are estimates as they are present value of costs and losses associated with pollutant emissions, discounted at an appropriate rate. The user interface 22 allows a user to enter search keywords and search and select the entity that the user intends to rate and assess a Point-in-Time Rating. Upon selection by user, information related to the entity, its organizational structure, its operating revenue, and all relevant financial metrics are extracted from the entity database. Also extracted are polluting production unit data associated with the entity either as operator or as owner. Emissions of respective pollutants are aggregated across all relevant polluting units according to rule. Social cost data associated with respective pollutants are extracted from the Emissions and Social Cost Database.

In Step 500, the entity's financial information is combined with its emission information before the entity is processed for data integrity.

At Step 600 the Ratings Scale and Values data are updated using an input interface. For instance, at time zero an entity will not have any ratings data or social cost data for its emissions. At time one, when an entity is rated and is provided a rating, say B3, this data is updated into the database 20. The data that was used to arrive at that rating is also stored in the database 20 so that it can be accessed, published and audited. When the rating is changed at time two, the rating is updated again with a time stamp and the data that was used to generate this new rating in time Two.

At Step 700, the software collates all the information about the entity. At this Step, the software runs an AI based accuracy check on all the data on the company. The AI process checks the information on that entity at Step 100, Step 200, Step 300, Step 400, and Step 500. This AI process is designed to ensure that the data on the entity is consistent, accurate and timely. This process creates three possible outcomes: (1) Pass; (2) Fail; and (3) Review. Only when the data passes the AI integrity check the software continues to process the data to Step 800. The AI integrity check, which can be support vector machines as a nonlimiting example, ensures that the data is reasonable. For example, a company producing 100 mw of power cannot produce 1 billion tons of CO₂. Therefore, large changes in emissions, revenue, or power purchases, not associated with some corporate event (e.g., sale or acquisition) should be flagged. Large SO2 and NOx emissions in the absence of a large coal-fueled capacity should be flagged. Similarly, low volumes of CO2, SO2, and NOx given a large coal-fueled generating capacity should be flagged. Large physical measures of Hg and SF6 should be flagged; these typically are low in absolute amounts. An extreme value more than 2× the next largest value should be checked.

At Step 800 the Entity's total socials costs (Total Social Costs) of all emissions are estimated and broken into two components: Social costs of Greenhouse Gases (GHG) emissions responsible for climate change (GHG Social Costs), and social costs of all other emissions. At this Step, all three social costs: Total, GHG Social Costs and Other Social Costs are normalized based on selected appropriate financial and operating metrics supported by data, including but not limited to revenue, operating income, valued added, expenditure, final deliveries, etc., described further in FIG. 2.

At Step 900, normalized social costs are rated based on the Ratings Scale. The comparison is done based on two processes—a naïve process and a genetic algorithm. The naïve process simply assigns a PIT rating to the entity using a mathematical calculation based on all the Ratings Scale Data. The genetic algorithm process takes the PIT rating estimated by the naïve process and the ratings for every other rated entity whose information is stored in the Entity's Final PIT ratings database and makes the final adjustment to the naïve PIT rating based on running simulations. For instance, 10,000 simulations could be run as a nonlimiting example, but the number of simulations could be as low as 500. The naïve PIT rating and the final PIT rating is stored in the Entity's Final PIT ratings database.

At Step 1000, the Naïve and the Final PIT ratings can be displayed on the user interface 22.

Example of a Direct Entity PIT Rating Approach

An electrical generating entity is identified, and data are downloaded. From corporate and public data sources for a target year (the most recent year for which comprehensive data are available), twenty power plants are identified as being owned and operated by the entity. From government and company data sources, plant specific emissions of CO₂, SO₂, NOₓ, CH₄ and N₂O are collected and aggregated. These are reviewed relative to corporate disclosures of aggregate emissions. Corporate and government sources also provide company aggregate emissions for Hg, and SF₆. Annual emission aggregates are then collated into a definitive table for rating purposes. Here, measured in tons as a nonlimiting example, the table would include CO2 (52,383,527), SO2 (29,479), NOx (23,644), CH4 (4,492), N2O (639), Hg (0.075), SF6 (5.698).

Unit social cost estimates are drawn from government and academic sources. Typically, these are expressed in real, constant dollar terms and must be converted to nominal dollars of the target year. This is performed through the use of factors derived from the Bureau of Economic Analysis GDP deflator, which have been downloaded into data systems and calculated.

These converted nominal unit social costs are now multiplied by respective emissions to obtain externality estimates per emission. This allows a separation of externalities between GHG associated externalities (those connected with CO₂, CH₄, SF6, and N₂O) on the one hand, and those externalities which are not GHG connected (SO₂, NOₓ, and Hg). As a nonlimiting example, the table would include 2018 social cost estimates, measured in $2018 per ton as follows: CO2 (43), SO2 (50,144), NOx (79,992), CH4 (1,213), N2O (15,400), Hg (4,730,000), SF6 (987,240). Consequent $2018 externalities of emissions are as follows: CO2 (2,268,206,727), SO2 (1,478,194,976), NOx (1,891,311,031), CH4 (5,448,533), N20 (9,847,590), Hg (352,983), SF6 (5,625,609). Entity externalities can now be summed across all emissions for an entity aggregate presented as total social cost of unremediated emissions in $2018: 5,658,987,448.

This estimate of aggregate externalities now must be scaled. An excellent scaling measure for this entity would be value added but data for this concept are unavailable. This actually is quite common. An alternative measure would be revenue, preferably operating revenue to remove one-off unusual revenue factors. Operating revenue for the fiscal target year was available. For Direct ratings, however, operating revenue, in itself, can be a faulty measure of scale. Electricity purchases for resale typically constitute a material component of supply yet the externalities associated with such production would not be captured in the collected data. Electrical generating entity secondary purchases of electricity are best thought of as purchased inputs. For this reason, purchased power is considered outside the definition of Scope 1 emissions of the Greenhouse Gas Protocols, a widely applied definition set for reporting emissions. Estimates of externalities associated with purchased electricity would be useful in the determination of externalities directly and indirectly associated with entity activity, but for a Direct Entity Rating, these are excluded both from the determination of aggregate externalities and for the scaling measure. Entity operating revenue for the fiscal target year was $11,233 mm. Purchased power in the fiscal target year was $973 mm, for an adjusted operating revenue measure of $10,260 mm.

Environmental externalities per $mm of the scaling measure, adjusted operating revenue, amount to $551,558. This would correspond to a rating of B3 in the rating scale presented in FIG. 1. The Direct Entity Point in Time Rating for this entity is B3.

Approach for Determining a Forward Output Rating

Forward rating module 18b works as follows. The final PIT ratings and associated data are then taken as an input by module 18b to produce Forward Ratings. The Forward Ratings are a function of conditions that generate the Point-in-Time rating calculated in Module 18a and the outcome of a simulation process in Module 18b. For several emitting entities, emissions of Greenhouse Gases and other pollutants have been declining. However, the time paths for totals of respective GHGs and for the separate GHG emission levels of respective emitting entities show variations in movement and their rate of change. Activity levels, as appropriately adjusted, will have their own trends and random variability around trend. Additionally, expected changes in regulation, in consumer choice, in the rate of change in average annual atmospheric temperatures, and in advancements in remediation technologies play an important role in forecasting the future path(s) of emissions as well as respective outputs. Module 18b models these future paths by a stochastic process with a trend and a periodic probabilistic shock. A general representation of the process is described below.

A common stochastic process with appropriate features may be presented as:

dm=μmdt+σmdz (1)

Where m represents the annual emissions of a particular kind of pollutant emitted from the operations of a given entity, μ is the trend rate of annual emissions, σ is the standard deviation of m, t is time measured in years, d is a differential operator, and:

dz=ε√dtε˜N(0,1) (2)

so ε is a standard normal variate.

Consider now, a transformation of m, the natural logarithm of m, denoted ln m, and let its differential be denoted as dG. Applying Ito's Lemma:

dG=d(ln m)=(μ−½σ²)dt+σdz (3)

This is the process for the percentage change in m for small changes. Considering that changes are measured over a yearly interval, it might be preferable simply to manipulate equation (3) to establish an expression for the stochastic process for the percentage change in m as:

(dm/m)=ρdt+σdz (4)

The difference between equation (3) and (4) is minor. Either can reasonably be used as a statistical process for projecting forward emission changes.

To apply either equation (3) or (4), the parameters μ and σ must be estimated. Using relevant historical emissions data and other factors as listed above (such as but not limited to expected changes in regulation, in consumer choice, in the rate of change in average annual atmospheric temperatures, and in advancements in remediation technologies), a trend annual percentage change may be determined as the basis for the parameter u. Entity specific or sector specific emission percentage change history combined with these factors can be used to parameterize G. Entity announcements and transition plans, regulatory announcements, and government policy pronouncements may also be used in adjusting historical estimates to determine the parameters according to the reasoned judgement of an authorized analyst or analytical group.

The differential equations above can be transformed into difference equations for purposes of practical application. Equation (1) can be expressed as:

mₜ−mₜ₋₁=μmₜ₋₁+σmₜ₋₁εt (5)

or as

mₜ=(1+μ)mₜ₋₁+σmₜ₋₁εt (6)

to facilitate simulations.

Simulations can be applied to determine respective emission paths. Emission paths for respective emissions can be joined together to establish an emission path set. Social cost per unit emission estimates can be applied across emissions to establish respective externality paths. Forward social cost estimates may be developed using integrated assessment model forecasts or other projections of real cost and adjustments for inflation based on economic forecasts or financial regulatory policy.

For each emission path set, the same methodology can be applied to simulate a revenue or adjusted revenue path. This will permit the determination of a ratio at the end of the paths which would support a terminal rating for each path.

In certain situations, it may be appropriate to simulate using a mean reversion term. The evolution of some variable “x”, might then be simulated using an equation such as:

xₜ=b(x*−xₜ₋₁)+(1+μ)xₜ₋₁+σxₜ₋₁εt (7)

where b is a parameter constant and x* is an appropriate target value. The parameter “b” is a non-negative fraction which represents the rate of reversion to target per unit time.

The simulations could be used to determine the likelihood that at a target terminal date, the entity rating will be different from its current point-in-time rating. They could be used to determine the average ratio of entity aggregate externality to revenue or adjusted revenue and the corresponding rating of that average at the target terminal date. Simulations could also be used to determine a probabilistic range of likely ratio outcomes with associated upper and lower boundary ratings.

Rather than simulating percentage change emission paths for respective emission types independently, it may be worthwhile to simulate the paths (and the revenue paths as well) in a correlated fashion. If sufficient information exists to estimate covariances for respective emission (and revenue) variables, a set of independently drawn shock variates can be transformed into appropriately correlated shock variates.

Let e be a vector of independently drawn shocks from a standard normal distribution. Let u be the transformed shocks which are appropriately correlated. Let e be transformed into u through a matrix multiplication such that:

u=He (8)

Let the matrix Σ be an observed variance-covariance matrix for the respective emission variables being simulated. Because the expected value of the elements of e are zero:

Σ=E(u u′)=E(Hee′H′) (9)

Here, E is the expected value operator and ‘ denotes transposition. Because the elements of e are standard normal variates, ee’ is the identity matrix and equation (9) reduces to Σ=HH′. As Σ is symmetrical, H is triangular. Provided that Σ has an appropriate property, the elements of the matrix H can be established as the Cholesky decomposition of Σ. Once the elements of H are determined, independent standard normal shocks can be transformed into shocks with an expected variance-covariance given by Σ.

Unit emissions external cost estimates are often generated by systems that project cost estimates to a variety of horizons. Projection to a particular target horizon may be achieved by linear interpolation or projection. Unit emission cost projections are typically expressed in constant dollar terms. These may be brought to current dollar terms using an index such as the Bureau of Economic Analysis GDP Deflator. A target horizon estimate for the Deflator can be made by applying an inflation forecast to the target horizon.

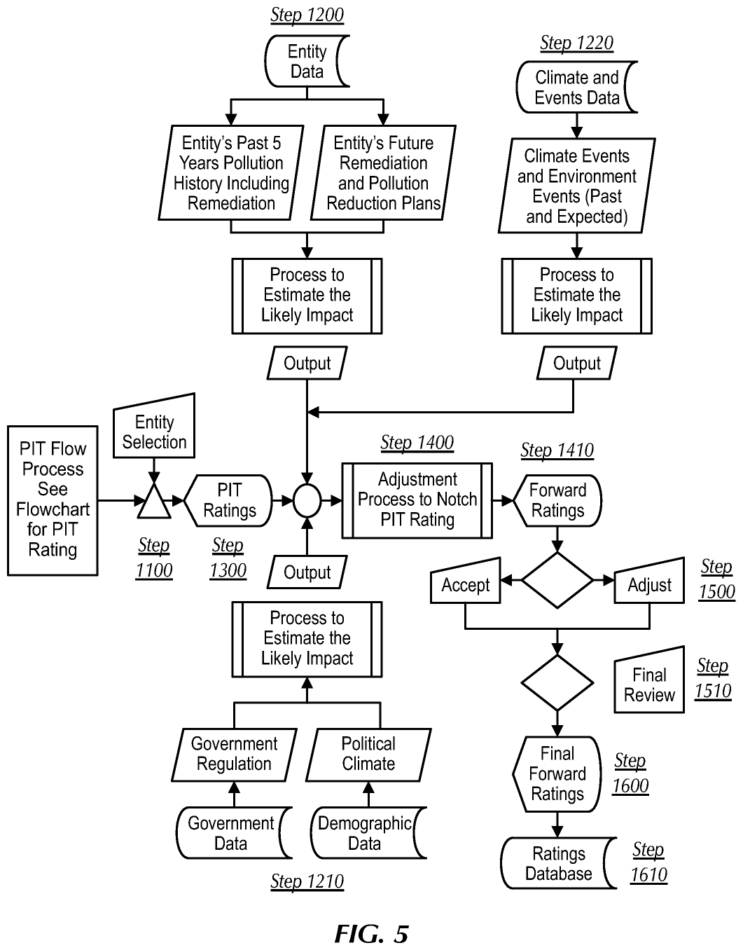

FIG. 5 generally depicts a flow chart for determining Forward Looking ratings. Step 1100 receives input as all PIT ratings from the PIT Ratings data table. The Forward Rating is an up or down adjustment to the PIT rating. In Step 1100, the user chooses an entity for calculating the Forward Ratings. Once the entity is chosen, the ratings module 18b looks up the database 20 and collects the following attributes from the entity table: Name of the entity and/or entity identifiers; Location; Type of the entity; Any financial instruments ID; Government ID; and Industry. In Step 1100, the ratings module 18b also looks up the PIT ratings for the entity and relevant information involved in the computation of the PIT rating. Such data inform the initial conditions of the Forward Rating calculations. The entity type and industry are important attributes for they are required in Step 1200 for running the simulation in Step 1200 and Step 1210.

Steps 1200, 1210, and 1220 are steps for performing forward simulations for various factors that may impact the Forward Rating. In Step 1200, the entity specific simulation is performed based on the entity history, future plans and industry history, and expected future trends. The simulation process creates an output that is the set of simulation bundles described above regarding forward rating.

In Step 1210, the impact of relevant projected Government Regulation, and relevant changes in consumer and investor choice and sentiment, supportable by available information, is simulated. The simulation produces an output.

In Step 1220, the impact of climate change, climate events, forecast of changes in atmospheric temperatures and other climate related data are used to simulate a magnifying or dampening impact of the forward path of the various simulation bundles.

In Step 1300, all simulation bundles are combined to produce a set of simulation bundles that can be used to project emissions per unit output in the future. In the same step, output unit emissions external cost estimates are generated; external estimates created by systems that project cost estimates to a selection of horizons are also provided using the interface.

In Step 1400, the software generates a Forward Rating adjustment to the PIT Rating for the entity and the adjustment rationale. A natural language processor (NLP) takes all the inputs from various simulations in Steps 1200, 1210, and 1220, and creates the adjustment rationale document. This adjustment can be up or down, for example, an entity receiving a PIT rating of B3 may be recommended for a two notch upgrades from B3 to B1 (a one notch upgrade would be from B3 to B2) or a two-notch downgrade to Ccc2 (a one notch downgrade would be from B3 to Ccc1).

In Step 1410, the adjustment is applied to the PIT rating and relevant information and the rationing adjustment rationale document is sent to the user interface in Step 1500.

In Step 1500, the user is given the opportunity to approve the Forward Rating adjustment to the PIT ratings. A user also has the opportunity to decline the recommendation generated by the software and make her own recommendations. Once the user approves or adjusts the notching recommendation, it is sent to Step 1510. In Step 1510, another user reviews and approves the final Forward Rating Recommendation.

In Step 1600, the final Forward Ratings are published along with the adjustment rationale produced in Steps 1400/1410 and all the data stored in the relevant databases.

Example of Forward Rating Approach

An illustrative example of Direct Entity Output Forward Rating calculation is provided. One hypothetical entity for illustrative purposes is a prominent US entity in the business of generating and transmitting electricity. The starting point for a Forward Rating is a Point-in-Time (PIT) rating using the PIT rating methodology described earlier. In creating a Point in Time rating, the system draws data from various databases regarding unremediated emissions of carbon dioxide (CO2), sulfur dioxide (SO2), nitrogen oxides (NOx), methane (CH4), nitrous oxide (N2O), mercury (Hg), and sulfur hexachloride (SF6). Information to support trend estimates existed for CO2, SO2, and NOx. As these are by far the most important emissions for determining environmental ratings for electricity generating entities, this is sufficient for the purposes of a forward rating. Based on the table in FIG. 1, the PIT Rating was deemed to be B3 based on an analysis of all the emissions data, their social cost, the entity's operating revenues for that particular year (appropriately adjusted), and the rating scale.

For a Forward Rating to be derived, the following must be obtained in addition to the Point-In-Time Rating and the data required to determine the PIT rating. An emission trend and a volatility feed must be obtained for each emission being projected to project adjusted output specific to that type of entity. Emission unit social costs must be projected forward on a real basis and then adjusted to forecasted price levels at the terminal forecast period. Emissions and adjusted output specific to this type of entity which, in this example, is a public utility, must then be simulated and combined into simulation bundle sets and the aggregate social cost at the terminal date across the emissions must be calculated and compared to the projected adjusted output specific to that type of entity. For each bundle, a ratio of projected social cost per million dollars projected adjusted output specific to that type of entity can thus be obtained. The mean of the distribution of outcomes can be taken to represent the foundation for the forward rating but other values can be taken from the distribution to create the foundation for boundary rating forecasts.

The simulation software uses data that was used for the Point in Time rating to establish initial conditions for Forward Ratings. These are unremediated emissions of carbon dioxide (CO₂), sulfur dioxide (SO₂), nitrogen oxides (NOₓ), methane (CH₄), nitrous oxide (N₂O), mercury (Hg), and sulfur hexachloride (SF6). Information to support trend estimates are available in the database for CO₂, SO₂, and NOR. As these are by far the most important emissions for determining environmental ratings for electrical generating entities, it is sufficient for the purposes of a forward rating. For this example, the other emissions were not simulated but projected forward at initial year levels. Additionally, the company's plans were examined to inform forward projections. For example, as the company expects to replace its current coal-fired plants with natural gas, it is reasonable to expect CH₄ (methane) will not decrease, as methane is released due to natural gas transportation and usage. Similarly, there is no reason to expect a decline in the emissions of SF6, which is generated from transmission lines. There might be reasons to expect N₂O and Hg emissions to decline but it is difficult to forecast to what extent. Currently, the emission levels are small enough that it is highly unlikely a projection error for this emission projection will have a material impact on the forward rating calculations.

Continuing with the example, a review of the entity's disclosures determined that between 2005 and 2018, the company had been reducing its CO₂ emissions at an average annual rate of 5%, sulfur dioxide at the rate of 20%, and nitrogen oxides at the rate of 16%. Between 2017 and 2018, the entity reduced its emissions at a faster rate but its forecasted annual rate of reduction of carbon emissions through 2030 was only 4%, which was slower than the historical rate from 2005 through 2018. Keeping in mind the rapid decline in the very recent history but the slower than average forecast for the longer-term future, the historical long-term average annual rates of change for the respective emissions were chosen as the trend parameters for a five year forward simulation running from 2018 through 2023.

The historical data on the entity revenue and adjusted revenue (operating revenue less the value of purchased electricity) is fed to a simulation to produce estimates of Forward Revenue and Adjusted Revenue. In the example of this entity, reflecting the recent historical record, the Forward Revenue and Adjusted Revenue are projected with a 0% annual increase trend.

Developing Volatility Feeds: The developed database includes percentage changes in emissions for companies and, where available, industries. There was insufficient information to determine a volatility from entity history, however, data stored in the database derived from the Energy Information Agency giving sector histories of annual CO₂, SO₂, and NOₓ emissions were available. From these series, the standard deviation of percentage change was determined for each respective series. These standard deviations were used to parameterize the volatility terms in respective emission projection equations. From the series for annual adjusted revenue, an associated series of percentage change in annual adjusted revenue was created. From that series, the standard deviation of percentage change was determined. This was used to parameterize the volatility term in the adjusted revenue projection equation.

Projection of Emission Unit Social Costs: Real unit emission social costs are given by the Federal government for CO₂, CH₄, and N₂O. Interpolations between the 2020 and 2025 projected unit social costs were used to determine unit social cost figures for 2023, the terminal year for the Forward Rating example presented here. Invariant real unit emission social cost estimates for the other projected emissions were obtained from published academic sources stored in the database. Once obtained, real unit emission social cost estimates for the respective emissions needed to be transformed from dollars of some base year into forecast horizon year dollars. The US Bureau of Economic Analysis GDP deflator was used to establish a base year divisor. The GDP Deflator ends at 2019. A projection of the Deflator to the simulation terminal year horizon was established using a 2% inflation assumption based upon the Federal Reserve near-term inflation target.

Once all the data and assumptions are fed into the software, the software needs to run simulations as described above. The simulation software follows the following generalized process:

Emissions were simulated using the formula:

m_{i,t}=(1+aᵢ)m_{i,t-1}+(σᵢm_{i,t-1})εₜ (10)

where m represents emissions, with respective emissions are indexed by i, al is the trend parameter for emission i, σᵢ is the volatility parameter for emission i, and t is a time index. Respective emissions i are simulated from the equation and then used to evolve emissions successively from respective initial conditions m_{i,0} which are the historical emissions observed for 2018. Successive evolutions take the simulation to a terminal date, which is, in this example, 2023.

In this example, five hundred paths are simulated for each respective emission. Adjusted revenue is projected via the equation:

rₜ=rₜ₋₁+σᵣrₜ₋₁εₜ (11)

where r is adjusted revenue with adjustments made to reflect an industry's idiosyncrasies, Gr is the volatility parameter (the standard deviation of percentage change of r), and t is a time index. Because there is no drift term (the drift parameter is 0), the simulation is constructed to take a random walk from the initial condition which is the adjusted revenue in 2018. The variable r is evolved five hundred times to a terminal outcome which in this example represents adjusted revenue in 2023.

Once simulations of emissions and adjusted revenue have been performed, they are bundled in the following way. The first simulation for each respective emission paths is bundled together with the first simulation of adjusted revenue. The second simulation of each respective emission path is bundled together with the second simulation of adjusted revenue, and so on. Consequently, there are 500 bundled simulation sets.

Each terminal emission value is multiplied by its associated terminal unit social cost. Social costs are then summed across all emissions to determine a 2023 simulated total externality estimate which is then divided by an associated terminal adjusted revenue. The resulting ratio is then re-expressed in terms of externality costs per million dollars of adjusted revenue. In this example, the simulation exercise results in a distribution of 500 ratios.

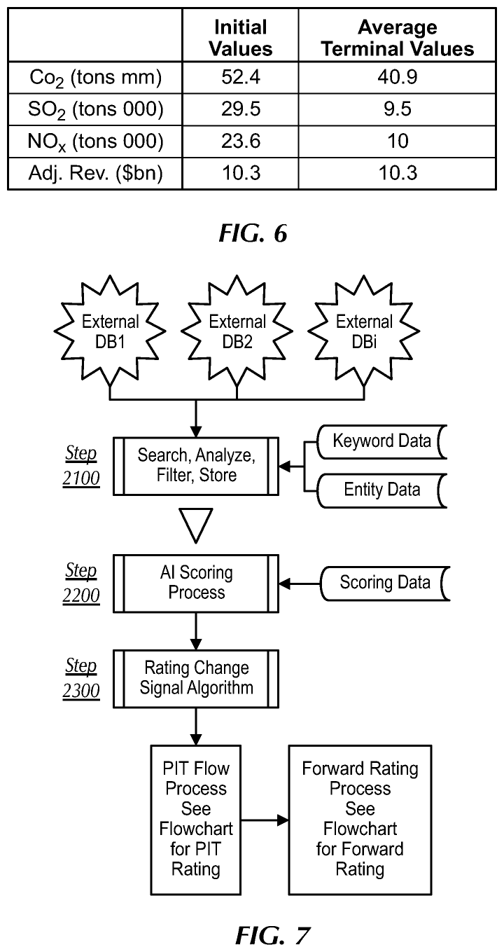

The Forward Rating and Boundary Rating Estimates: The initial and average terminal outcomes for the respective emissions and adjusted revenue are presented in the table in FIG. 6. The simulated percentage changes for the average values are very close to values implied by the annual trend parameters which suggests the simulations have been performed properly. The Point in Time Rating (which uses emission and adjusted revenue levels which constitute initial conditions for the Forward Rating) for the entity was calculated to be B3 (approximately $551 thousand in externalities per million dollars of adjusted revenue). The mean externality outcome per million dollars for the simulation terminal values for the Direct Forward Entity Output Rating in this example was approximately $340 thousand which falls within the B1 rating category. Substantial reductions in emissions were partially offset by rising real and nominal unit social costs (if the costs go down, the ratings would improve on that account); consequently, the expected rating 5 years forward is only two notches better than the 2018 Point in Time rating for the entity. The standard deviation of the 500 simulated forward rating ratios was approximately $46000. The mean forward rating ratio −2 standard deviations is just above $250 thousand which is the boundary to the next highest rating. It can be said, therefore that while it is possible the rating for the entity five years forward might improve to Bb3, that outcome is unlikely. The mean forward rating ratio +2 standard deviations is about $430 thousand. It can be said, therefore that five years forward, it is unlikely the rating would fall below B2 based on a ratings scale as shown in FIG. 1. While this is an example specific to an electricity generating company, conditioned on data availability, the same software process can be used to develop a forward-looking rating for any entity using entity specific output as listed in FIG. 2.

Approach for Surveillance and Monitoring

The Ratings Module 18c is an entity surveillance and monitoring software that monitors public and private information and data sources for information related to the entity and the factors that might impact its environment rating, for example, changes in regulation, actions taken by the company, or by the regulators for or against the company. FIG. 7 generally depicts a flow chart for surveillance and monitoring of the ratings module 18c.

Step 2100 includes software code that scans all the locally and remotely collected sources of data and information. These sources of information may include internal databases, external database, public and government websites, news organizations websites, financial information websites and other databases. The ratings module 18c searches for the keywords stored in the keywords database for each entity stored in the entity database. A search engine searches all items that contain the entity's name or any item related to environmental regulation and climate change among other items. The search engine then analyzes, categorizes, filters and stores all the information and tags it by entity name.

In Step 2200, the AI Scoring process scores each information item related to an entity based on the scoring system set up in the scoring table. Once an entity is rated, it is given a score of 50 and this score is stored in the scoring database. Additionally, each search term has a score that ranges from −20 to 20. For example, a search term “endorsement of a green initiative” has a score of 0.05 while a search term “environment disaster” has a score of −20. Additionally, each search term has a life which is different for different search terms. Continuing with our example, “endorsement of a green initiative” has a life of 60 days, while “environment disaster” has a life of 10-years. It should be noted these scores are exemplary and not intended to be limiting. An event can therefore have any life between 60 days and 10 years.

In Step 2300 the AI system uses a moving time window for scoring and keeps on adding information item scores to the entity score. So, on day 1 for example, an entity may have 32 search items that add up to say 1.2. The score of the entity is now 50+1.2=51.2. This score becomes the baseline score for day 2. The AI process continues to add scores until the day 60 (using a scoring window of 0-60 days as a nonlimiting example). Should the score reach 65 or higher, the entity is ready for consideration for PIT and Future Rating upgrade. Should the score drop below 35, the entity is ready for consideration for PIT and Future Rating downgrade. Again, these numbers are exemplary and not intended to be limiting.

The AI process keeps on moving the scoring window. On the 61^{st} day, the scoring window moves to [1,61], on day 2 to [2,62] etc.

Beyond the surveillance systems described, once sufficient information has been recovered to update PIT and forward ratings, these are recalculated and indicative ratings are compared to those on file for respective entities. Alerts are generated for rating confirmations, upgrades, or downgrades.

Example of Surveillance and Monitoring Approach

A large coal mining entity located in Peru has been given a PIT rating of B3 and a Forward Rating of Ccc1 using the PIT and Forward Rating software modules described elsewhere. As part of the risk the analysis the AI surveillance and monitoring system has identified several potentially very significant environmental risks.

One of the most important risks that the AI system has identified is the artificial lake that stores mining trailings. This lake is on the top of the mountain. Trailings is a liquid mainly containing water, mud, ore and is a byproduct of mining operation. Trailings is environmentally hazardous and can create significant risk to the regional biome, including human life and vegetation should the lake not be able to hold its integrity.

The PIT rating is of B3 is based on as of date while Ccc1 rating is the Forward Rating. The Forward Rating is based on the information provided by the entity and the simulations done by the Forward Rating Module (19) which incorporate a probabilistic view of the lake.

Given the lake in on the top of mountain, the AI based surveillance system has been provided with the initial conditions to constantly surveil public and private sources of news and information. These initial conditions include: (1) There is a trailings lake; (2) The lake is on the top of the mountain; (3) There is a dam on the lake; (4) Downstream of the dam are scores of villages; (5) Dam's integrity is of the highest importance; (6) Should the dam break or be breached the environmental damage will be signification with very high social costs; and (7) The initial score by default is set at 50.

The AI system has now been activated for surveillance and monitoring of this company. After 24-hours of scanning the environment for information on the entity, the AI system has generated multiple red flags related to the entity's operations. These red flags include safety violations, firing of safety auditors, agitation by people. Each red flag has been scored individually due to which the initial score has been determined to be 43 instead of 50. Given the number of red flags the AI system has determined that instead of initial score of 50 the company needs to be assigned a lower score of 40 due as the likelihood of an event has increased.

The AI systems scans the environment every day and continues to filter and assign news and other information items to different categories based on a pre-defined classification. On day 45, its scans a news item that a safety auditor has been fired (terminated) from his position at the entity. By itself, the news item is not significant so a low score of −0.1 is assigned to this news, however, because the company already has various violations related to the Trailings lake, the AI system runs 10,000 simulations of the possible impact of the event on the safety of the lake and the people living downstream to the dam and the score is adjusted to −2 and the final score is updated to 38 (40-2).

Because this is a safety related issues and the company already has safety violations, the life of the safety-inspector-termination is increased from 60-days to 2 years. On day 180, its scans a news item that another safety auditor has been fired (terminated) from his position at the entity. Again, by itself, the news item is not significant so a low score of −0.1 is assigned to this news, however, because the company already has various violations related to the Trailings lake, and had already fired an inspector in the last six-months, the AI system runs 10,000 simulations of the possible impact of the event on the safety of the lake and the people living downstream to the dam and the score is adjusted to −4 and the final score is updated to 34 (38-2).

Since the score has breached the lower limit of 35, the AI system issues a notification to the PIT and Forward Ratings Modules that the entity ratings need to be reviewed for a “downgrade” PIT and Forward Ratings Modules would then take over.

Applications Integrating Embodiments of the Environmental Ratings

There can be various uses for the disclosed ratings, both market-based and social/regulatory. The following are some of the ways embodiments of the environmental ratings could be used.

Policymaking and Regulatory use:

Regulators and policymakers at local, state and federal level can use the ratings in numerous ways. For example, they can use ratings for licensing purposes and implement a licensing fee based on the rating the company has received. This licensing fee can be annual and be significant enough either to pay for the social costs or to force behavior change. They can also use the ratings to manage their environmental footprint. Another way policymakers at the federal level can use the ratings is by imposing a surcharge per financial transaction (equity or debt) and transmitting that revenue to an agency set up for remediation. Afterall, the environmental ratings proposed are expressions regarding the likely impact of company activity from which investors and management are benefitting, reflecting an expectation of discounted costs. A rating below a certain threshold could trigger an add-on charge, perhaps expressed in terms of basis points per annum, which would be remitted as a tax to the government. A precedent for a basis point tax charge on issuance already exists; a 10-basis point GSE guarantee fee surcharge currently is levied to replace payroll taxes that were temporarily reduced during the Great Recession. Where costs are demonstrably lower than forecast, surcharge taxes can be adjusted.

As an Input to Credit Ratings Analysis:

One of the most direct uses of the ratings would be in credit analysis and ratings assignment. As discussed earlier, credit rating agencies are making efforts to incorporate ESG risks into their credit assessments. While those efforts are laudable, a standalone environmental rating can act as an unbiased universal measure that encompasses purely environmental factors and provides a direct proxy for the all possible environment related risks that a company faces. This is because the environmental rating can describe the social cost in monetary terms a polluter is transferring via externalities which is exactly equal to economic/financial risk (though in the maximum) the polluter faces. Therefore, credit rating agencies can use the ratings as a direct input to their ratings analysis and can adjust the economic cost/risk to a particular company based on their knowledge of the industry and region/regulation and how likely is that company to be regulated and what percentage of total social costs the company might be forced to bear. This “adjusted social cost” can then be used to appropriately calibrate financial statements to arrive at Environmental Ratings adjusted ratios that can be used for credit ratings

Self-Assessment:

One of the great uses of our the disclosed ratings system is in making an assessment of its social cost foot print by a company. Afterall, companies know exactly what pollution causing inputs (and outputs) are involved in their economic activity. Using the disclosed system, a company can create a document outlining every input and its social cost and arrive at an “indicative rating” which can then either be published as a “self-rating” or a “ratified rating” after it being certified by a third-party. This self-assessment rating can create a much greater level of transparency than any method currently in place. It is clearly much easier to compare pollution footprints based on standardize methods that produce a letter rating than comparing various public disclosure documents with different formats, requirements and even different units of measure.

Consumers:

The disclosed ratings system can be used an input by consumers for making more informed purchasing and consumption decision. Environmentally conscious consumers may want to look at the rating before purchasing products from a company. They may be willing to pay more for products from a company that has higher rating than for products from a company that has low rating. Consumers, in the extreme, may even want to boycott products from companies that are rated exceptionally low on the environmental rating scale. Such consumer actions could possibly provide enough incentives for companies to make efforts that will make them move up the rating scale.

Various corporate and financial organizations:

Such firms may wish to adapt the disclosed rating system to create benchmarks for evaluation purposes, investment products and structure various financial instruments linked to pollution reduction initiatives.

### CONCLUSION

As such, generally disclosed herein are embodiments for an environmental rating system and method. The environment rating system and method rates every entity based on the amount of unremedied pollution it produces. The rating system includes socio-economic costs of known pollutants emitted by the rated entity per unit of economic output as well as a rating scale based on a unit of economic output.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

1. A system for providing an environmental rating to an entity, the system comprising one or more processors configured to determine a point in time (PIT) rating by:
receiving an entity-specific unremediated emissions amount for a predetermined period of time; receiving an entity-specific scaling measure for the predetermined period of time;
receiving externality cost values for each entity-specific unremediated emission;
determining an aggregate externality cost for the entity based on the entity-specific unremediated emissions amount and each associated externality cost value;
determining an indicative rating ratio based on the aggregate externality cost for the entity and the entity-specific scaling measure;
comparing the indicative rating ratio to categories in a ratio rating table and select a rating defined by an interval into which the indicative rating ratio falls; and
outputting the selected rating.

2. The system of claim 1, wherein the processors comprise a PIT ratings module configured to determine the PIT rating.

3. The system of claim 1, wherein the entity-specific unremediated emissions amount, entity-specific scaling measure, and externality cost values for each entity-specific unremediated emission are received from one or more databases.

4. The system of claim 1, wherein the processors are further configured to check if there is a published purchase for resale value when the environmental rating is a direct emissions rating.

5. The system of claim 1, wherein the processors are further configured to determine the aggregate externality cost scaling measure for the entity based on a published purchase for resale value when the environmental rating is a direct emissions rating.

6. The system of claim 1, wherein the entity-specific scaling measure comprises adjusted revenue when the environmental rating is a direct emissions rating.

7. The system of claim 1, wherein the processors further comprise a forward looking module configured to determine a forward looking rating by: modeling a future path of the outputted PIT rating via a stochastic process with a trend and a periodic probabilistic shock;
and adjusting the outputted PIT rating based on the modeled future path.

8. The system of claim 1, wherein the processors further comprise a monitoring module configured to monitor factors that impact the environmental rating of the entity to determine when the PIT rating should be updated.

9. A method for providing an environmental rating to an entity comprising:
determining a point in time (PIT) rating via a PIT ratings module of one or more processors by:
receiving an entity-specific unremediated emissions amount for a predetermined period of time;
receiving an entity-specific scaling measure for the predetermined period of time; receiving externality cost values for each entity-specific unremediated emission;
determining an aggregate externality cost for the entity based on the entity-specific unremediated emission amount and each associated externality cost value;
determining an indicative rating ratio based on the aggregate externality cost for the entity and the entity-specific scaling measure;
comparing the indicative rating ratio to categories in a ratio rating table and selecting a rating defined by an interval into which the indicative rating ratio falls; and
outputting the selected rating.

10. The method of claim 9, further comprising checking if there is a published purchase for resale value when the environmental rating is a direct emissions rating.

11. The method of claim 9, further comprising determining the aggregate externality cost scaling measure for the entity based on a published purchase for resale value when the environmental rating is a direct emissions rating.

12. The method of claim 9, wherein the entity-specific scaling measure comprises adjusted revenue when the environmental rating is a direct emissions rating.

13. The method of claim 9, further comprising determining a forward looking rating via a forward looking module of the processors by: modeling a future path of the outputted PIT rating via a stochastic process with a trend and a periodic probabilistic shock; and adjusting the outputted PIT rating based on the modeled future path.

14. The method of claim 9, further comprising determining when the PIT rating should be updated via a monitoring module of the processors configured to monitor factors that impact the environmental rating of the entity.

15. A non-transitory computer-readable medium having stored thereon a computer program for execution by a processor configured to perform a method for providing an environmental rating to an entity, the method comprising:
determining a point in time (PIT) rating by:
receiving an entity-specific unremediated emissions amount for a predetermined period of time;
receiving an entity-specific scaling measure for the predetermined period of time; receiving externality cost values for each entity-specific unremediated emission;
determining an aggregate externality cost for the entity based on the entity-specific unremediated emission amount and each associated externality cost value;
determining an indicative rating ratio based on the aggregate externality cost for the entity and the entity-specific scaling measure;
comparing the indicative rating ratio to categories in a ratio rating table and selecting a rating defined by an interval into which the indicative rating ratio falls; and
outputting the selected rating.

16. The non-transitory computer-readable medium of claim 15, wherein the method further comprises checking if there is a published purchase for resale value when the environmental rating is a direct emissions rating.

17. The non-transitory computer-readable medium of claim 15, wherein the method further comprises determining the aggregate externality cost scaling measure for the entity based on a published purchase for resale value when the environmental rating is a direct emissions rating.

18. The non-transitory computer-readable medium of claim 15, wherein the entity-specific scaling measure comprises adjusted revenue when the environmental rating is a direct emissions rating.

19. The non-transitory computer-readable medium of claim 15, wherein the method further comprises determining a forward looking rating by:
modeling a future path of the outputted PIT rating via a stochastic process with a trend and a periodic probabilistic shock; and
adjusting the outputted PIT rating based on the modeled future path.

20. The non-transitory computer-readable medium of claim 15, wherein the method further comprises determining when the PIT rating should be updated via a monitoring module of the processors configured to monitor factors that impact the environmental rating of the entity.
